(19) United States
(12) Patent Application Publication
(10) Pub. No.: US 2011/0320766 A1
(43) Pub. Date: Dec. 29, 2011

(54) APPARATUS, METHOD, AND SYSTEM FOR IMPROVING POWER, PERFORMANCE EFFICIENCY BY COUPLING A FIRST CORE TYPE WITH A SECOND CORE TYPE

(76) Inventors: Youfeng Wu, Palo Alto, CA (US); Shiliang Hu, Los Altos, CA (US); Edson Borin, San Jose, CA (US); Cheng C. Wang, San Ramon, CA (US); Mauricio Breternitz, JR., Austin, TX (US); Wei Liu, San Jose, CA (US)

(21) Appl. No.: 12/826,107

(22) Filed: Jun. 29, 2010

(51) Int. Cl. G06F 9/30; G06F 15/76

(52) U.S. Cl. 712/28; 712/1; 712/E09.016

(57) ABSTRACT

An apparatus and method is described herein for coupling a processor core of a first type with a co-designed core of a second type. Execution of program code on the first core is monitored and hot sections of the program code are identified. Those hot sections are optimize for execution on the co-designed core, such that upon subsequently encountering those hot sections, the optimized hot sections are executed on the co-designed core. When the co-designed core is executing optimized hot code, the first processor core may be in a low-power state to save power or executing other code in parallel. Furthermore, multiple threads of cold code may be pipelined on the first core, while multiple threads of hot code are pipeline on the co-designed core to achieve maximum performance.

### FIELD

This invention relates to the field of processors and, in particular, to optimizing power, performance efficiency.

### BACKGROUND

Advances in semi-conductor processing and logic design have permitted an increase in the amount of logic that may be present on integrated circuit devices. As a result, computer system configurations have evolved from a single or multiple integrated circuits in a system to multiple cores, multiple hardware threads, and multiple logical processors present on individual integrated circuits. A processor or integrated circuit typically comprises a single physical processor die, where the processor die may include any number of cores, hardware threads, or logical processors.

The ever increasing number of processing elements—cores, hardware threads, and logical processors—on integrated circuits enables more tasks to be accomplished in parallel. However, processors that employ all out-of-order cores may lead to power inefficiencies and/or performance inefficiencies under some circumstances. As a result, some hardware-software co-designed systems have been developed to confront the power-performance efficiency problem. In that system, a wide, simple in-order processor may be utilized, while software optimizes and schedules programs to run on the in-order hardware efficiently.

Yet, hardware-software co-designed systems are typically associated with two adverse impacts: (1) translation and/or optimization of code utilizing a binary translator may slow down some applications with short running tasks and small response-time constraints (a binary translation glassjaw); and (2) an in-order processor may not perform well for some styles of programs that are better suited for parallel execution (an in-order glassjaw).

To illustrate the binary translation (BT) glassjaw issue, an example of a typical profile for execution of a Microsoft Excel application is examined. For 10 billion dynamic x86 instructions executed, simulation illustrates that 23% of dynamic instructions are from static instructions, which are repeated less than 100,000 times; this may be referred to as cold code. If these x86 instructions are interpreted and translated using binary translation software (with the typical overhead for translation/interpretation and performance gain with optimizations), the cold code will take approximately 3.6× more instructions to run than native x86 execution. And, the translation causes the entire 10B instructions to execute 1.4× more instructions. Taking into account an approximation of 25% of executed code is cold code, then on average, translation overhead will make the cold code to run 4.4× slower. And cause the whole execution to run 1.7× slower than the native execution.

To illustrate the in-order glassjaw, an example with performance of an in-order processor as compared to an out-of-order processor during benchmark simulation is examined. During the simulation of a number of programs on similar equipped in-order and out-of-order (OOO) processors, it was seen that approximately 40% of programs ran 1.57× faster on the OOO processor, while approximately 40% of programs ran 1.45× faster on the in-order processor. Although these simulations are purely illustrative and may vary in results, they illustrate that both systems potentially include inefficiencies in power and/or performance.

### BRIEF DESCRIPTION OF THE DRAWINGS

The present invention is illustrated by way of example and not intended to be limited by the figures of the accompanying drawings.

FIG. 1 illustrates an embodiment of a processor including two asymmetric cores.

FIG. 2 illustrates an embodiment of a processor including a native core, a software-managed core, and a code distribution module

FIG. 3 illustrates an embodiment of a processor for distributing code among cores to achieve maximum performance and maximum power savings.

FIG. 4 illustrates an embodiment of a flow diagram for a method of distributing code among an out-of-order core and an in-order core to achieve maximum performance and power savings.

FIG. 5 illustrates another embodiment of a flow diagram for a method of distributing code among an out-of-order core and an in-order core to achieve maximum performance and power savings.

### DETAILED DESCRIPTION

In the following description, numerous specific details are set forth such as examples of specific types of processor cores, specific processor configurations, specific hot code region identification algorithms, specific structures for storing translated/optimized code, specific division of tasks between hardware/software, specific processor units/logic, etc. in order to provide a thorough understanding of the present invention. It will be apparent, however, to one skilled in the art that these specific details need not be employed to practice the present invention. In other instances, well known components or methods, such as specific and alternative processor architecture, specific logic circuits/code for described algorithms, specific code implementations, specific binary translation details, and other specific operational details of microprocessors haven't been described in detail in order to avoid unnecessarily obscuring the present invention.

The method and apparatus described herein are for implementing a native core with a software-managed core to achieve maximum performance and power savings. Specifically, the collaboration between cores is discussed primarily in reference to an out-of-order core and an in-order, co-designed core. Yet, the apparatus' and methods described herein are not so limited, as they may be implemented in any distribution of code between asymmetric cores. For example, the code distribution methods and apparatus' described herein may be utilized with two out-of-order cores that implement unique Instruction Set Architectures (ISAs). Furthermore, the collaboration between such cores is often discussed as split between hardware mechanisms and code/software. However, any blend or exclusive use of hardware, software, and/or firmware my be utilized to implement the methods and apparatus' described below.

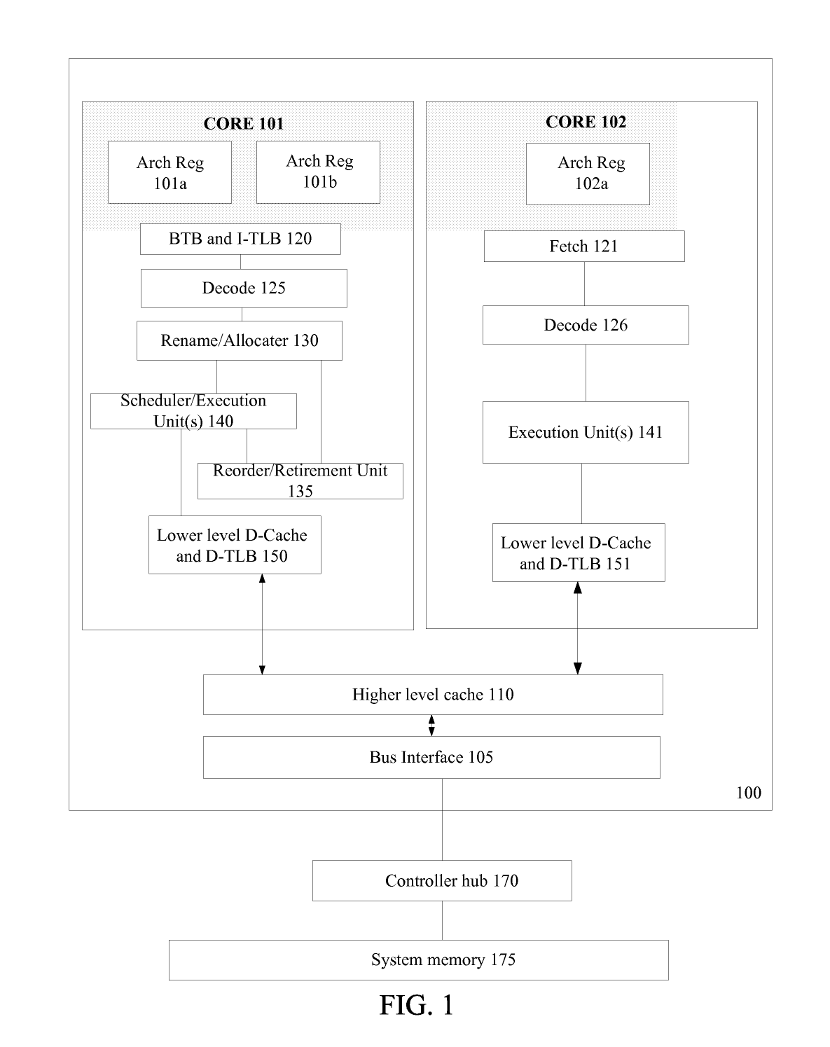

Referring to FIG. 1, an embodiment of a processor including multiple cores is illustrated. Processor 100 includes any processor, such as a microprocessor, an embedded processor, a digital signal processor (DSP), a network processor, or other device to execute code. Processor 100, in one embodiment, includes at least two cores—core 101 and 102—of different types. However, processor 100 may include any number of processing elements.

In one embodiment, a processing element refers to a thread unit, a thread slot, a process unit, a context, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor typically refers to an integrated circuit, which potentially includes any number of other processing elements, such as cores or hardware threads.

A core often refers to logic located on an integrated circuit capable of maintaining an independent architectural state wherein each independently maintained architectural state is associated with at least some dedicated execution resources. In contrast to cores, a hardware thread typically refers to any logic located on an integrated circuit capable of maintaining an independent architectural state wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 100, as illustrated in FIG. 1, includes two cores, core 101 and 102. Here, core 101 and 102 are considered asymmetric cores, i.e. cores with different configurations, functional units, and/or logic. In one embodiment, core 101 includes an out-of-order processor core, while core 102 includes an in-order processor core. However, cores 101 and 102 may be individually selected from any type of core, such as a native core, a software managed core, a core adapted to execute a native Instruction Set Architecture (ISA), a core adapted to execute a translated Instruction Set Architecture (ISA), a co-designed core, or other known core. Yet to further the discussion, the functional units illustrated in FIG. 1 are described in further detail below.

As depicted, core 101 includes two hardware threads 101a and 101b, which may also be referred to as hardware thread slots 101a and 101b. In contrast, core 102 includes one hardware thread 102a. Therefore, software entities, such as an operating system, in one embodiment potentially view processor 100 as three separate processors, i.e. three logical processors or processing elements capable of executing three software threads concurrently. Alternatively, a software entity may only view processor 100 as having two separate processors—thread slots 101a and 101b—while the described code distribution mechanisms manage execution of code on core 102.

As eluded to above, a first thread is associated with architecture state registers 101a, a second thread is associated with architecture state registers 101b, and a third thread may be associated with architecture state registers 102a. As illustrated, architecture state registers 101a are replicated in architecture state registers 101b, so individual architecture states/contexts are capable of being stored for logical processor 101a and logical processor 101b. Architecture state registers 102a may be the same as registers 101a, 101b. Or registers 102a may instead be unique to the architecture of core 102. In core 101, other smaller resources, such as instruction pointers and renaming logic in rename allocater logic 130 may also be replicated for threads 101a and 101b. Some resources, such as re-order buffers in reorder/retirement unit 135, ILTB 120, load/store buffers, and queues may be shared through partitioning. Other resources, such as general purpose internal registers, page-table base register, low-level data-cache and data-TLB 115, execution unit(s) 140, and portions of out-of-order unit 135 are potentially fully shared.

Processor 100 often includes other resources, which may be fully shared, shared through partitioning, or dedicated by/to processing elements. In FIG. 1, an embodiment of a purely exemplary processor with illustrative logical units/resources of a processor is illustrated. Note that a processor may include, or omit, any of these functional units, as well as include any other known functional units, logic, or firmware not depicted. As illustrated, core 101 is illustrated as a simplified out-of-order (OOO) processor core. The OOO core includes a branch target buffer 120 to predict branches to be executed/taken and an instruction-translation buffer (I-TLB) 120 to store address translation entries for instructions.

Core 101 further includes decode module 125 coupled to fetch unit 120 to decode fetched elements. Fetch logic, in one embodiment, includes individual sequencers associated with thread slots 101a, 101b, respectively. Usually core 101 is associated with a first Instruction Set Architecture (ISA), which defines/specifies instructions executable on processor 100. Here, often machine code instructions that are part of the first ISA include a portion of the instruction (referred to as an opcode), which references/specifies an instruction or operation to be performed. Decode logic 125 includes circuitry that recognizes these instructions from their opcodes and passes the decoded instructions on in the pipeline for processing as defined by the first ISA.

In one example, allocator and renamer block 130 includes an allocator to reserve resources, such as register files to store instruction processing results. However, threads 101a and 101b are potentially capable of out-of-order execution, where allocator and renamer block 130 also reserves other resources, such as reorder buffers to track instruction results. Unit 130 may also include a register renamer to rename program/instruction reference registers to other registers internal to processor 100. Reorder/retirement unit 135 includes components, such as the reorder buffers mentioned above, load buffers, and store buffers, to support out-of-order execution and later in-order retirement of instructions executed out-of-order.

Scheduler and execution unit(s) block 140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 150 are coupled to execution unit(s) 140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

As stated above, in one embodiment, core 102 includes an in-order, co-designed core. As a result, FIG. 1 illustrates a simplified pipeline of an in-order core. This pipeline includes fetch unit 121, decode unit 126, execution unit(s) 141, and a lower-level data cache 151. These units may work in a similar manner to the corresponding units in core 101. Yet, in an in-order core, the instructions/operations are executed in program order, instead of potential out-of-order execution as in core 101. In one example, out-of-order core 101 is referred to as the native core, while the in-order core 102 is referred to as a co-designed core. Alternatively, in-order core 102 is the native core and out-of-order core 101 is the co-designed core.

Here, cores 101 and 102 share access to higher-level or further-out cache 110, which is to cache recently fetched elements. Note that higher-level or further-out refers to cache levels increasing or getting further way from the execution unit(s). In one embodiment, higher-level cache 110 is a last-level data cache—last cache in the memory hierarchy on processor 100—such as a second or third level data cache. However, higher level cache 110 is not so limited, as it may be associated with or include an instruction cache. A trace cache—a type of instruction cache—instead may be coupled after decoder 125 to store recently decoded traces.

In the depicted configuration, processor 100 also includes bus interface module 105 to communicate with devices external to processor 100, such as system memory 175, a chipset, a northbridge, or other integrated circuit. Memory 175 may be dedicated to processor 100 or shared with other devices in a system. Common examples of types of memory 175 include dynamic random access memory (DRAM), static RAM (SRAM), non-volatile memory (NV memory), and other known storage devices.

In one embodiment, code is distributed between core 101 and 102 based on maximizing performance and power. For example, code regions are identified to perform better on one of the two cores 101, 102. As a result, when one of such code regions is encountered/detected, that code section is distributed to the appropriate core. Identification of such regions may be done statically (before execution of the code, such as through program profile analysis) or dynamically (during execution of the code) by hardware, software, or a combination thereof.

In one illustrative example of a dynamic approach, one processor core, such as core 101, may be selected as a default core to execute code based on its performance, power-savings, native ISA, any other known processing consideration, or a combination thereof Then, regions of the default code that execute poorly on core 101, or would execute better on core 102, are identified. Upon subsequently encountering those identified code sections, they are distributed to core 102 for execution. Note that execution of those regions on core 102 may include speculative, run-ahead execution to warm-up core 101, serial execution of those regions on core 102 with execution of other regions on core 101 that depend on results from those regions, or parallel, concurrent execution of those regions with execution of other code on core 102.

In an example of a static approach, a compiler or user may identify sections of code, such as with instructions or demarcations, that execute better on one core or the other. Here, core 101 executes code until such an instruction is encountered. Either in response to monitoring from core 102 or by sole initiative (triggering) of core 102, the identified code section is then executed on core 102 based on the encountered instruction.

Whether identification of code sections to run better on one core or another is done dynamically or statically, in some embodiments, native code is translated and/or optimized to be run on another core. For example, assume core 101 includes decode logic 125 that recognizes a first ISA type, and core 102 includes decode logic 126 that recognizes a second ISA type. In this case, if a code region of the first ISA type is to be executed on core 102, then the code region is translated to the second ISA type to be executed on core 102. Note that translation between ISA types is purely illustrative. Instead, out-of-order optimized code to be executed on core 101 may be re-optimized for execution of in-order core 102. In this scenario, core 102 may include the same, or a subset of, the same ISA as core 101. Yet, optimizations are performed on the code to ensure it runs more efficiently on a simple, wide in-order core.

The collaboration between core 101 and core 102 to distribute code efficiently may be implemented in hardware, firmware, software, or a combination thereof. The example above regarding a dynamic approach to identifying code regions is further examined to illustrate exemplary embodiments of collaboration mechanisms. In the example, program code, in a native format, is optimized to execute on out-of-order core 101. During execution of a code region or the program code, monitor hardware associated with core 101 and/or core 102 may be utilized to determine the performance associated with core 101's execution of the code region. Alternatively, code, such as software, OS code, micro-code, or other code, may be executed on core 102, to determine/monitor the performance of core 101 in executing the code region. If it's determined that the code region would be better executed on core 102, then hardware, software, firmware, or a combination thereof may be utilized to translate and/or optimize the code region to be executed on core 102.

As a result, when core 101 encounters the code region again—an instruction pointer references the code region, an identifier instruction to identify the code region is fetched or decoded, or another way of identifying a code region is detected—then the translated/optimized version of the code region is executed on core 102. In one embodiment, during execution of the code region on core 102, core 101 may concurrently execute other code regions to increase overall program execution performance. Note that concurrent or parallel execution may include execution of separate software threads on cores 101, 102 as well.

In contrast, threads may be pipelined on cores 101, 102. As an example of this scenario, assume each of the two software threads includes multiple stages of code (hot, cold, etc). Here, cold code from a first thread may be executed on core 101, and when a hot region is encountered, a translated hot region is executed on core 102. During execution of the translated hot region of code on core 102, cold code from the second thread may be executed on core 101. On core 102, when execution of the first translated hot code completes, execution of another hot region from the second software thread may then be executed. As can be seen from this example, the stages of code may be interleaved on each core resulting in a pipelined type of execution. In another embodiment, code may be executed sequentially with respect to the two cores, such as a code region on core 101, the identified code region on core 102, and then subsequently another code region on core 101.

In addition, even when a code region is initially identified for execution on core 102, the performance of that execution may also be monitored. The performance on both cores may then be taken into account in determining which core is best suited to execute the code region to achieve maximum performance and power savings. For example, if a code region is identified to be executed as translated code on core 102, but the performance on core 102 is below the performance on core 101 (or the performance gain on core 102 doesn't outweigh the power savings of execution on core 201), then the code may be re-distributed to core 101 upon subsequent encounters.

FIG. 1 illustrates an abstracted, logical view of an exemplary processor with a representation of different modules, units, and/or logic. However, note that a processor utilizing the methods and apparatus' described herein need not include the illustrated units. And, the processor may omit some or all of the units shown. Furthermore, a majority of the discussion above has been in reference to an out-of-order processor core and an in-order processor core. However, as aforementioned, the two processor cores may be any version of asymmetric cores, such as a native core and a software managed core. In addition, FIG. 1 only depicts two cores; yet, a processor may include any number of cores, such as multiple cores of the same type, as well as more than two cores that each differ in type.

FIG. 1 also illustrates an embodiment of processor that is coupled in a point-to-point fashion with an interface to an external memory controller (controller hub 170). However, many current processors have begun including an on-processor memory interface module—an on-chip module—with a ring configuration to interconnect multiple cores, as well as shared caches and other interfaces. Although not illustrated, processor 100, in one embodiment, includes a ring interconnect coupling core, cache, and memory controller components.

Here, caching agents are utilized to manage a slice of a physically distributed cache. As an example, each cache component is to manage a slice of a cache for a collocated core—a core the cache agent is associated with for purpose of managing the distributed slice of the cache. Much like cache agents handle traffic on a ring interconnect and interface with cache slices, core agents/components are to handle traffic and interface with cores. Additionally, the ring interconnect may couple Memory Controller Interface Logic (MCIL) and/or other controllers to interface with other modules, such memory and/or a graphics processor.

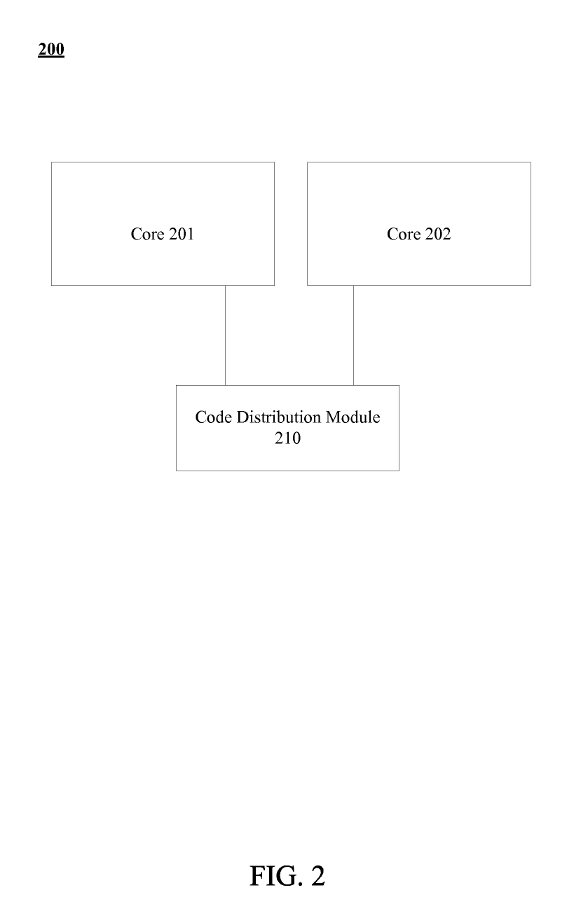

Referring to FIG. 2 an embodiment of a code distribution module to distribute code among two cores is illustrated. In one embodiment, cores 201, 202 are asymmetric cores. For example, core 201 is an out-of-order (OOO) core adapted to execute code out of original program order, and core 202 is an in-order (or serial core) adapted to execute code in program order. A non-exhaustive exemplary list of other core types include: a native core, a non-native core, a software managed core, a native ISA core, a translated ISA core, a co-designed core, a speculative execution core, and a non-speculative execution core.

In one embodiment, code distribution module 210 is to distribute code between core 201 and 202 based on maximizing performance and power savings. A module as used herein may refer to hardware, software, firmware, or a combination thereof. Additionally, a module, unit, or logic may be centralized in a core or processor, as well as distribute throughout. For example, code distribution module 210 may include distribution code, such as micro-code or software, held in storage associated with core 201, core 202, processor 200, or a system including processor 200. Here, the distribution code, when executed, is to perform the code distribution. In contrast, the code distribution process may be managed by hardware, software, firmware, or a combination thereof

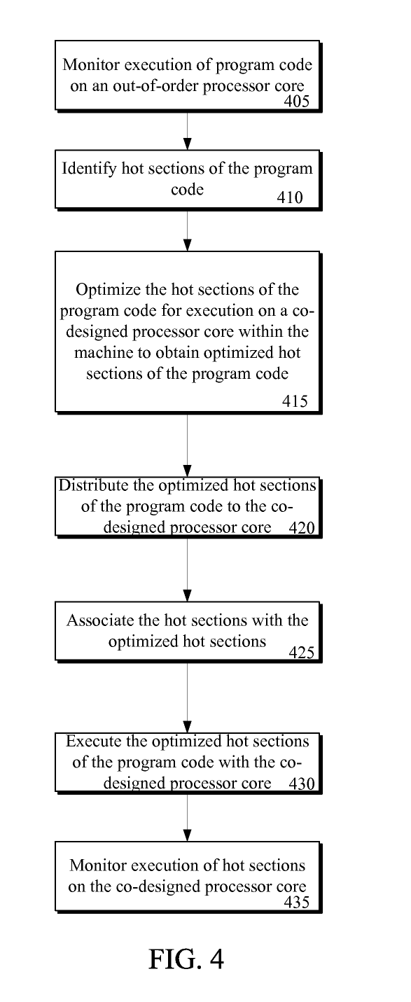

In one embodiment, code distribution module 210 is to identify a hot portion of program code. Program code is discussed in more detail below in reference to FIG. 4. However, as an illustrative example for this section of discussion, program code may include any code to be executed with a processing element, such as binary or machine code. A hot portion of code may refer to a portion of code that is better suited to execute on one core over the other based on considerations, such as power, performance, heat, other known processor metric(s), or a combination thereof. Here, assuming core 201 is a default core for native execution of the program code, then identification of a hot portion of the program code includes determining a portion of code that is better suited to be executed on core 202. In the embodiment where core 201 is an OOO core and core 202 is an in-order core, then a hot portion of code may refer to a hot spot of the program code that is better suited to be executed on serial core 202, which potentially has more available resources for execution of a highly-recurrent section. As an example, a hot portion of code is identified by a recurrence pattern of the portion of code, or some other known metric, such as instruction count or cycle count. Often a section of code with a high-recurrence pattern may be optimized to be executed more efficiently on an in-order core. Essentially, in this example, cold code (low-recurrence) is distributed to native, OOO core 101, while hot code (high-recurrence) is distributed to software-managed, in-order core 102.

A hot portion of code may be identified statically, dynamically, or a combination thereof. In the first case, a compiler or user may determine a section of program code is hot code. Here, a hot code identifier instruction(s) may demarcate a section of code as hot, i.e. to be executed on core 202 instead of on core 101. Decode logic in core 201, in one embodiment, is adapted to decode a hot code identifier instruction from the program code, which is to identify the hot portion of the program code. The fetch or decode of such an instruction may trigger translation and/or execution of the hot section of code on core 202. In this example, the code distribution module 210 includes the decode logic to detect the hot code detection instruction. And module 210 may also include other hardware and/or software to carry out the translation/optimization, as well as the execution of the hot code on core 202. Alternatively, the hot-code section may be pre-optimized/translated for execution on core 202.

In another example, code distribution module 210 dynamically (during execution) identifies hot spots/regions in program code. In one embodiment, hardware included in core 201 and/or core 202 is utilized to profile execution of the program code on a core, such as core 201. Based on the characteristics of the profile—power and/or performance metrics associated with execution—a region of the program code may be identified as hot code. Similar to the operation of hardware, monitoring code may be executed on one core, such as core 202, to perform the monitoring/profiling of program code being executed on the other core, such as core 201. Note that such monitoring code may be code held in storage structures within the cores, within processor 200, or held in a system including processor 200. For example, the monitoring code may be microcode, or other code, held in storage structures of core 201, core 202, or processor 200. And, the monitoring code may be executed by traditional execution units, as well as other firmware or logic on processor 200.

As yet another example, a static identification of hot code is made as a hint. But dynamic profiling of the program code execution is able to ignore the static identification of a region of code as hot; this type of static identification is often referred to as a compiler or user hint that dynamic profiling may take into account in determining which core is appropriate for code distribution. Moreover, as is the nature of dynamic profiling, identification of a region of code as hot doesn't restrict that section of code to always being identified as hot. For example, assume program code is being executed on an out-of-order core 201. Monitor code executing on core 202 monitors the performance level of core 201's execution of a section of the program code. Based on the implementation, if the performance on core 201 is determined to be enough lower than it would perform on core 202 and/or a recurrence pattern of the code section on core 201 is high-enough to be predicted to hide core transition overhead; then the code section is identified as hot. After translation and/or optimization, a translated version of the code section is executed on core 202. Similar to the monitoring of execution on core 201, the execution of the translated version of code may be monitored on core 202, such as through execution of the performance monitoring code. If the performance is lower on core 202 than on core 201, then the identification of the code section as hot may be dynamically reversed (the section of hot code may be relabeled as cold code).

Once a section, spot, or region of codes is identified as hot, code distribution module 210, in one embodiment, optimizes and/or translates the hot section of code to obtain optimized/translated hot code. In one embodiment, translation and/or optimization code, such as binary translation code, is held in storage logic of core 202. As an example, the binary translation code may be part of micro-code held in core 202. The translation/optimization code, when executed, translates/optimizes the code section for execution on core 202. In one embodiment, core 201, 202 may recognize the same ISA, or a subset thereof, where translation/optimization is merely translating/optimizing code to execute more efficiently on core 202. In another embodiment, core 201, 202 recognize different ISAs, where translation includes translating the code region from one ISA recognizable by core 201 to another ISA recognizable by core 202. Although translation/optimization is discussed in reference to execution of translation/optimization code, any known mechanism for translating/optimizing code, even through exclusive hardware, may be utilized.

In one embodiment, upon encountering an identified section of hot code with core 201, the hot code (a translated version thereof) is executed on core 202. Any known trigger for determining when a hot code region is encountered may be utilized. A few high-level examples include: encountering/referencing an instruction address associated with the code region, fetching/decoding/scheduling/executing an instruction identifying a code section as hot code, fetching/decoding/scheduling/executing an instruction indicating a translated version of hot code is to be executed on another core, an external trigger from a monitor indicating a hot code region has been encountered, etc.

As an illustrative example, code distribution module 210 includes a monitor module implemented in hardware, software, or a combination thereof. When the monitor module identifies a hot region of code or translates the hot region to a translated region, the monitor module registers an instruction address associated with the hot region of code. This registration may include association of the instruction address with a location of the translated region of code. Then, when an instruction pointer (program counter) subsequently references the instruction address, it's determined from the registered instruction address that a hot region of code has been encountered. Note that any form of detection may be used here, such as a synchronous or asynchronous interrupt style of handling the encounter event. Additionally, hardware, micro-code, and/or firmware may be capable of directly handling the encounter of a hot code section without interrupt-like handling, i.e. the trigger event isn't serviced by a handler. Note that core 101 and 102 may share certain hardware structures, such as a mapping structure, to identify addresses that are registered as hot code.

In response to encountering a hot code section on core 201, a translated and/or optimized version of the hot code section is executed on core 202. Despite how the hot code section is identified and encountered on core 201, any known method for enabling execution of code on another core may be utilized. In one embodiment, a collaboration module is utilized to enable such execution. For example, cores 201, 202 may share certain hardware structures and/or include communication channels to share information. As one example, cores 101, 102 may share a data cache, so when execution is migrated from core 201 to 202, the data isn't physically moved, but rather is already resident in the shared cache. Similarly, a register file, such as a shadow register file, in one embodiment, is shared between cores 201 and 202, so register states (context) doesn't have to be migrated from one core to another. As an alternative, instead of sharing a register file, a high-speed interconnect may be used to physically migrate context, or a portion thereof, from one core to another. Additionally, with infrequent transfers software may be utilized to perform such transfers.

As one example, input values into a hot code-section are transferred from core 201 to core 202 to support execution of the hot-code section on core 202. After execution, output values are then transferred back to core 201. In one embodiment, only identified input/output values from code sections are transferred, i.e. a partial context switch. Note that such input values may be identified by the user (software/compiler) and/or by hardware/firmware algorithms. Here, direct access hardware may be adapted to read input values from registers, buffers, or other structures in core 201 and write them to core 202. Inversely, the same or different hardware may be utilized to read values from core 202 and write them to core 201. However, where identifying such values becomes too cumbersome, an entire context switch, replication, or sharing may be performed to provide values between cores 201 and 202.

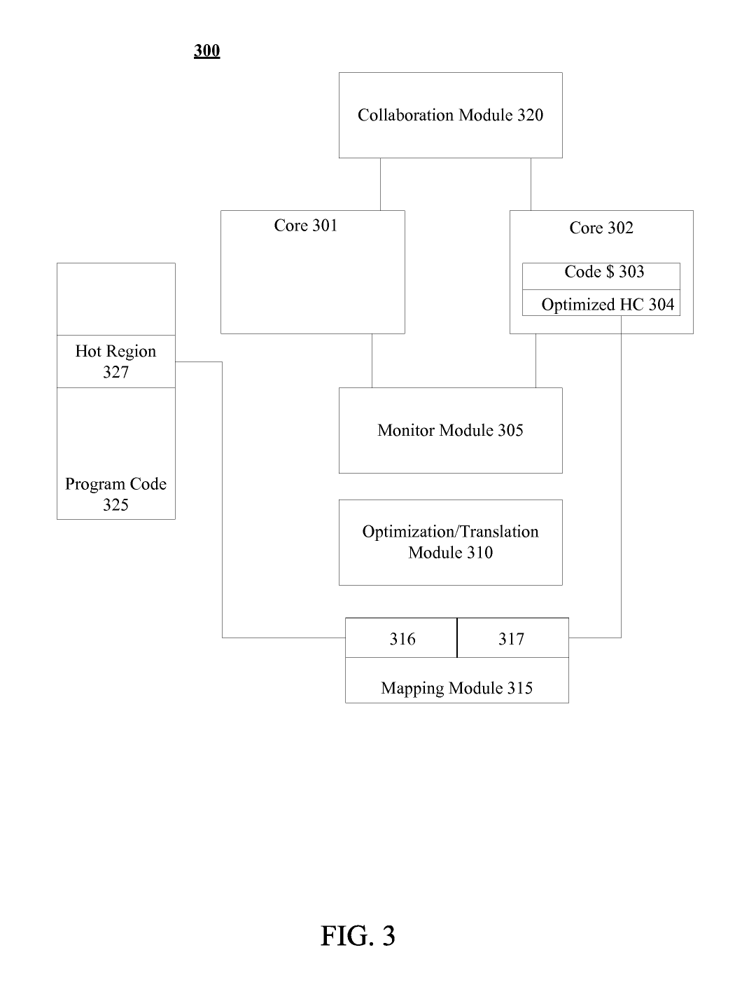

Referring next to FIG. 3, an embodiment of a processor for distributing code among cores to achieve maximum performance and power savings is depicted. As above, processor 300 includes two processor cores; each of which is of a different core type. As one example, core 301 is a native, out-of-order (OOO) processor core, while core 302 is a software managed, in-order processor core. Core 301 and 302 may, but are not required to, recognize different ISA types. In fact, core 302 may recognize a subset of core 301's ISA. Or, core 302 may include a separate ISA that partially overlaps core 301's ISA. As described above, a core or processor is often associated with an ISA—a definition of recognized instruction—by decode hardware/software in the core or processor.

In one embodiment, monitor module 305 is to monitor execution of native program code 325 on native, OOO core 301; through this monitoring, module 305 is to identify a hot portion/region 327 of the program code 325. Monitor module may be comprised of hardware, software, or a combination thereof. In one embodiment, monitor module 305 includes hardware to monitor execution. As one example, the hardware includes micro-architectural and/or architectural hooks, such as retirement pushout tags/counters to measure retirement pushouts, instruction counters to count numbers of instructions, overall trace execution measurement logic to measure overall execution length and/or time, recurrence counters to count a number of times a code section was executed, etc., to determine performance/power metrics during execution of code 325. This type of hardware may be located in any portion of an integrated circuit/processor, such as within out-of-order core 301, within in-order core 302, and in a non-associated portion of the integrated circuit that is not included within either OOO processor core 301 or the in-order processor core 302.

In another embodiment, monitor module 305 includes software, such as monitor code, which when executed, is to monitor execution of program code 325 and to identify a hot region 327 of the program code 325. As an illustrative example, processor 300 includes storage structures, such as Read Only Memory (ROM) structures, programmable logic, etc, to hold code, microcode, or machine code, when executed, causes the monitoring to occur. However, monitor code may be stored in any machine readable medium associated with cores 301, 302. Note that use of the term execution is not only limited to execution by traditional execution units, but instead may refer to execution by other hardware or programmable logic associated with processor 300, such as execution of microcode with firmware. Here, the executed monitor code may perform the same monitoring of recurrence, power, and performance metric that is measureable by hardware.

As one example, the monitoring hardware and/or code tracks/determines recurrence patterns for code sections of the program code. As a simple example, a data structure associates a reference to a code section (code region 327), such as an instruction address, with a count of the number of times the instruction address/code section has been executed on core 301. Note that the count may be associated with an absolute count (total count) or a temporal count (a count over an amount of time).

In one embodiment, monitor module 305 is adapted to identify/detect a hot portion 327 of program code 325. Monitor module 305, in one example, is to measure one or more performance metric(s) for the hot portion 327 of the program code 325 during execution on OOO processor core 301. And module 305 is to identify the hot portion 327 of program code 325 in response to the performance metric(s) on the OOO processor core being below a threshold. A non-exhaustive, illustrative list of examples of performance metrics include: instruction retirement pushout, a number of instructions executed, an amount of time to execute a code region, a number of times a code regions is encountered/executed, an amount of power consumed during execution of a code region, an amount of time spent in different power states during execution of a code region, a thermal density during execution of a code segment, etc.

Using one of the examples above, assume OOO core 301 is executing program code 325. And monitor code is being executed to determine a number of times regions of program code 325 are executed on core 301. When that count meets or exceeds a threshold, in one embodiment, monitor module 305 identifies/determines that region 327 is hot code. If a threshold value of three is used, then when monitor code executing on core 302 detects hot region 327 being re-executed a third time on core 301, region 327 is identified as a hot region of code. The specific example of determining a recurrence pattern may be extrapolated to see that a similar process—count, compare against a threshold, and identify—may be employed for any measured performance metric. Furthermore, determining a performance metric is not limited to simple counts, but may include any known algorithm for determining execution or power savings performance in a core, processor, or computer system.

However, identifying hot region 327 within program code 325 is not limited to dynamic performance monitoring. Instead, compiler or static program analysis may be utilized to determine code sections that are likely to be better suited for execution on in-order core 302. For example, assume program analysis reveals that hot region 327 is likely to be re-executed a number of times. In response to this discovery, a compiler or user may insert instructions or demarcations identifying a section of code as hot code. Therefore, when decoders of core 301 encounter such instructions, they recognize that region 327 is hot code that is to be executed on core 302. Note that in some embodiments, users may identify such regions of code based on their knowledge of a program without in-depth program analysis.

In one embodiment, in response to identifying region 327 as hot, code 327 is optimized or translated by optimization/translation module 310 to obtain optimized hot code 304. Similar to operation of monitor module 305, optimization module 310 may be implemented in hardware, software, firmware, or a combination thereof. For example, translation and/or optimization code may be stored in structures associated with core 302, core 301, or processor 300. To illustrate, binary translation code is stored in firmware associated with core 302. And the binary translation code is executed to translate hot region 327 from a native format for core 301 to a format for core 302. Note that translation may be between ISAs or other formats, while optimization may include any known method for optimizing code for execution, such as known techniques for optimizing code from parallel execution on OOO core 301 to serial execution on core 302, as well as the inverse.

However, use of binary translation code in firmware is purely illustrative, as any translation code or optimization code may be held anywhere in a computer system, such as microcode in core 302 or regular program code in a system memory. And, the optimization code may executed in any manner to translate or optimize hot region 327 to obtain optimized hot code 304. In fact, any known methods or apparatus' for translating or optimizing code for a core, such as the methods and apparatus' known for translating code in current software managed processors may be used.

Whether software, firmware, hardware, or a combination is to be used, translation may be performed statically or dynamically. In fact, much like monitoring may be done dynamically during runtime or statically before execution, translation and optimization may similarly be performed. In the example where a compiler or user identifies hot region 327, the optimization and translation may take place at that point (before execution). Here, a hot code identifier instruction may be utilized to both identify hot code region 327 and specify the location of the optimized/translated code 304. However, no matter if section 327 is identified as hot code before or during execution, the optimization and translation, in some embodiments, takes place dynamically (during runtime).

In one embodiment, hot region 327 is optimized/translated in parallel with other execution. In one example, core 302 begins executing optimization code in parallel with core 301's execution of region 327. Here, monitor module 305 detects execution of hot code region 327 on core 301, so optimization is initiated on core 302. While further instructions from hot region 327 are still being executed on core 301, core 302 begins optimization. As a result, core 302 is essentially optimizing hot code 327 in parallel with execution of hot code 327 on core 301. In another example, core 301 executes other sections of program code 325 or other mutually exclusive code in parallel to core 302's optimization of hot code 327. In another embodiment, optimization of hot region 327 is done serially. For example, core 301 executes hot region 327, and then subsequently core 301 or 302 optimizes hot code region 327.

In one embodiment, code 327 is stored at its original memory location and translated on the fly by core 302. However, in most cases, it's more efficient to translate/optimize an entire code section before execution. As a result, after optimization/translation module 310 optimizes code for a core, such as core 302, the optimized hot code 304 is stored elsewhere. The other location for optimized hot code 304 may be another location in memory, such as a home, system memory location. Yet, since hot code 327 is often associated with frequent execution, it's potentially advantageous to hold optimized version 304 closer to core 302. Therefore, in the illustrated embodiment, core 303 includes a code cache 302 to hold the optimized hot code 304. Note that code cache 303 may be a separate cache structure in core 302; a shared cache structure, such as a shared instruction or data cache in core 302; or other general storage structure associated with core 302.

Referring back to the discussion of monitor module 305, one embodiment of encountering hot code region 327 includes a program counter referencing an instruction address associated with a code section. As depicted, mapping module 315 is to hold code region reference, such as the instruction address, associated with optimized hot code reference 317. Essentially, an entry of mapping module 315 associates hot code region 327 with an optimized version thereof (optimized hot code 304). As an illustrative example, reference 316 includes an address, such as the instruction address, associated with hot region 327. In this scenario, when core 301 encounters (a program counter points to) the instruction address held in field 316 of mapping module 315, then monitor module 305 indicates that hot region 327 has been encountered and is to be executed on core 302. Collaboration module 320, which is briefly described above and discussed in more detail below, then facilitates the movement of data and/or context to core 302 for execution.

Determining hot region 327 has been encountered and is to be executed on core 302, in the above example, is only on reference 316. The association of field 317 with field 316 may then be utilized to quickly determine where optimized hot code version 304 of region 327 is located. As a result, field 317 may include any reference to the location of optimized hot code 304. A few simple examples of such a reference include: an address of an entry in code cache 303 holding optimized code 304, an offset from the start of code cache 303 to entry 304 holding optimized hot code, and a physical or linear address associated with entry 304. Mapping module 315 is illustrated in a simple table structure, which may be implemented and/or maintained in hardware, software, firmware, or a combination thereof. Yet, any known method for associating one location with another location may be utilized for associating hot code 327 with an optimized version thereof

Although not specifically illustrated, portions of monitor module 305 in combination with mapping module 315 may form a trigger module for indicating optimized hot code 304 is to be executed on core 302, instead of native code 327 on core 301. As an example, when a program counter for core 301 is moved to a next instruction address, trigger hardware checks that address against references stored in mapping hardware table 315. Here, assume the program counter points the instruction address that references code region 327 held in field 316. Then, the trigger hardware, based on the entry in mapping table 315, indicates that an optimized code region 304 for code region 327 exists. As a result, execution of code region 327 on core 301 may be elided, since an optimized version already exists and is to be executed on core 302.

In one embodiment, core 301 halts execution (stops or transitions into a low power state) until core 302 completes execution of the optimized code. However, this may not take full advantage of the processing capacity of processor 300. Therefore, in another embodiment, core 301 interleaves execution of another software thread (code other than program code 325), while optimized hot code 304 is executing on core 302. As yet another example, core 301 may execute other portions of program code 325 speculatively, which essentially performs a run-ahead helper thread of execution, or executes other portions of code 325 that don't depend from code region 327 out-of-order.

Collaboration module 320, in one embodiment, provides collaboration functionality between cores 301, 302. As the simplest example, collaboration module 320 includes an interconnect between cores 301, 302 to transfer information. Yet, in another embodiment collaboration module includes other hardware, which may be exclusive to individual cores or shared between, to facilitate the aforementioned collaboration. For example, core 302 may share a shadow register file of core 301, such that a full context switch of register state from core 301 to core 302 does not have to be performed when optimized hot code 304 is executed on core 302. Instead, core 302 is able to directly access the shadow register file in that scenario. However, collaboration module is not only limited to shared structures and/or an interconnect. In fact, collaboration module 320 may include hardware, firmware, software, or a combination thereof to provide direct read and/or write access to registers, storage structures, and buffers in both cores 301, 302. As a result, collaboration module 320, in one embodiment, is capable of transferring data/register values needed for execution of optimized hot code from core 301 to core 302. And, it's also capable of transferring results back from core 302 to core 301 to enable subsequent proper execution on core 301.

Although monitor module 305 has primarily been discussed in reference to monitoring execution on native core 301, monitor module 305, in one embodiment, is also to monitor execution of optimized code on core 302. As a result, monitor module 305 is capable of comparing performance of code section 327 on core 301 with performance of an optimized version 304 on core 302. Furthermore, when performance on core 302 is lower than performance on core 301, or the performance gain is small on core 302 in comparison to an increase in power consumption, then the decision to identify region 327 as hot code may be reversed. As an example, the entry of mapping module 315 indicating such a decision is de-allocated or invalidated; such that the next time core 301 encounters hot code 327, monitor module 305 doesn't detect reference 316 and doesn't indicate an optimized hot code version of region 327 should be executed on core 302. Essentially, the reversal migrates the previously identified region 327 back to out-of-order core 301.

As a specific illustrative example to further demonstrate this performance comparison, assume code region 327 is identified as hot code based on a high-recurrence pattern and a high-instruction execution count. As a result, code 327 is optimized by binary translation code resident on core 302 to obtain optimized code 304. When optimized code 304 is stored in code cache 303, an entry in mapping table 315 is created to associate code region 327 with optimized version 304. When core 301 next encounters a reference that matches the reference in field 316, then execution of optimized code 304 is triggered on core 302, instead of executing code region 327 on core 301. Note that collaboration module through transfer, sharing, or context switching provides the proper values from core 301 to core 302. During core 302's execution of optimized hot code 304, the same performance metric—instruction execution count—is tracked by monitor module 305. If the instruction execution count is less than code region 327 was executed on core 301, then the status quo of region 327 being identified as hot code continues in the future. However, if the instruction execution count is longer on core 302 or a significant power increase is detected, then the identification of region 327 as hot code may be reversed, as described above.

In addition to providing communication between cores 301 and 302, collaboration module 320 may also include other features to manage multiple cores of different types. As a first example, a power manager implements a power algorithm to ensure core 301 and 302 don't operation at maximum power at the same time. However, this example is purely illustrative. And other power algorithms may allow such maximum operation. As another power consideration, core 302 may reside in a power state below maximum (a low-power state) during monitoring of execution on core 301. For example, when core 301 is associated with mechanisms to perform its own monitoring, then core 302 doesn't need to be fully powered until there is an optimized version of code to be executed. As a result, power is potentially saved by turning off core 302 until it's needed for execution. Inversely, core 301 may be power down (put in a power state above maximum, such as an ACPI low power state), while core 302 is executing optimized hot code.

Turning to FIG. 4, an embodiment of a flow diagram for a method of distributing code among an out-of-order core and an in-order core to achieve maximum performance and power savings is illustrated. Although the flows of FIG. 4 are illustrated in a substantially serial fashion, the flows may be performed in a different order, as well as in parallel. For example, flows 410 and 415 may be performed during compilation of program code before the program is executed on an out-of-order core in flow 405. Furthermore, each of the flows may be performed utilizing hardware, firmware, or through execution of program code.

In flow 405, execution of program code on an out-of-order (OOO) processor core in a processor is monitored. Reference to program code, in one embodiment, refers to (1) execution of a compiler program(s), either dynamically or statically, to compile other program code; (2) execution of main program, such as an operating system, hypervisor, application code, or other software program; (3) execution of other program code, such as libraries, associated with the main program code, (4) execution of other program code, such as helper threads or other tasks, which may not be directly associated with main program; or (5) a combination thereof.

A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle end, which illustrates the blurring of delineation between a front-end and back end of a compiler. As a result, reference to insertion, association, generation, or other operation of a compiler may take place in any of the aforementioned phases or passes, as well as any other known phases or passes of a compiler.

In one embodiment, monitoring execution of program code comprises tracking a number of times code segments/regions within the program code are executed. Code regions may be determined in any known manner of grouping instructions/code. As an example, each time an instruction address associated with a code section is referenced by a program counter of the OOO core, a recurrence count is incremented. If the recurrence count for the code section exceeds a threshold, in one embodiment, the code section is identified as hot code in flow 410.

Either in conjunction with determining recurrence patterns or separately, monitoring execution of program code may include determining/tracking a performance metric associated with code sections. As disclosed above, exemplary performance metrics include: instruction retirement pushout, a number of instructions executed, an amount of time to execute a code region, a number of times a code regions is encountered/executed, an amount of power consumed during execution of a code region, an amount of time spent in different power states during execution of a code region, a thermal density during execution of a code segment. Yet, any known metric, or combination of merics, associated with processor execution may be monitored during execution of the program code.

In flow 410, hot sections of the program code are identified based on recurrence patterns, performance metrics, or a combination thereof. Similar to the example above, where a recurrence count is compared to a threshold, performance metrics may also be compared to a threshold. For example, a monitor may count the number of retirement pushouts that exceed a pushout time threshold. And if the pushouts exceed a count threshold, then the code section is identified as a hot section of code. Although this example discloses only a single performance metric as a consideration, identifying hot code sections of code may be based on any combination of performance metrics and/or recurrence patterns. For example, an algorithm may be devised for evaluating a plurality of performance metrics, power considerations, and a recurrence pattern to identify a code section as hot code. As the algorithm would be implementation specific and the number of permutations would be extensive, the details of a combinational algorithm is not discussed in detail to avoid unnecessarily obscuring the description. As described above, identifying code sections as hot code may be done before execution of the program code, such as by a compiler during compilation of the program code, or at runtime by a runtime compiler, hardware, firmware, other software, or a combination thereof.

In response to identifying hot code regions, the hot sections of the program code are optimized for execution on a co-designed processor core to obtain optimized hot sections of the program code in flow 415. In one embodiment, such optimization includes translating the hot sections of the program code from native instructions, which are recognizable by decode logic associated with the out-of-order processor core, to co-designed instructions, which are recognizable by decode logic associated with the co-designed core. However, translation is not required. In fact, in some embodiments, the co-designed core may be a serial core capable of executing the same ISA as the out-of-order core, or a subset thereof. In this scenario, the code may not be translated from one ISA to another, but rather translated/optimized from a format for out-of-order execution to a format for serial execution. Any known method for translating and/or optimizing code, such as known compiler methods for analyzing, translating, transforming, and/or optimizing code, may be utilized. As a specific illustrative example, binary translation code may reside on the co-designed core to translate/optimize the program code to the optimized hot section of the program code.

The optimized hot sections of the program code are distributed to the co-designed processor core in flow 420. In one embodiment, distribution includes writing the optimized hot sections of the program code to a code cache associated with the co-designed core. However, distribution may be done from any storage structure and at any time. For example, the optimized hot sections may be stored in a system memory and distributed to the co-designed core immediately before execution.

In flow 425, the identified hot sections of the program code are associated with the optimized hot section of the program code. For example, a reference to the hot section of the program code and a reference to the optimized hot section is stored in an entry of a code mapping table. Continuing the code cache example, the reference to the optimized hot section includes any reference to the location of the optimized hot code within the code cache, such as an address or offset. However, any known data structure and/or method may be utilized to associate the hot code section with the location of the optimized version thereof.

Then, when the code sections are encountered during execution on the out-of-order core, the optimized hot sections of the program code are executed with the co-designed processor core, instead of the out-of-order core, in flow 430. As stated above, execution of the optimized hot sections of code may take place in parallel with execution of other code on the out-of-order core or in serial with other code on the out-of-order core based on the design implementation. However, in the parallel implementation, the out-of-order core may be capable of executing other code from the same thread as the optimized hot code, as well as code interleaved from other threads.

In flow 435, execution of optimized hot sections on the co-designed processor core is monitored in a similar manner to the monitoring performed in flow 405 of execution on the out-of-order processor core. For example, the same performance metrics monitored in flow 405 may also be monitored during execution of the optimized hot section of the program code with the in-order, co-designed processor core. And it may be indicated that the hot section of program code is to be executed with the out-of-order core, instead of executing the optimized hot section of the program code with the in-order core, in response to the performance metrics indicating less performance on the in-order core as compared to the out-of-order core.

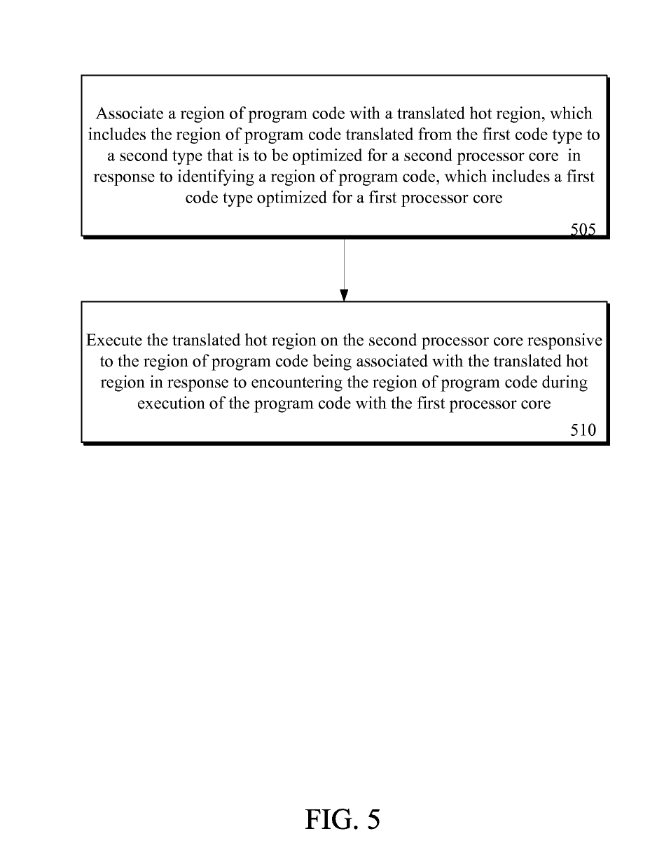

Turning to FIG. 5, another embodiment of a flow diagram for a method of distributing code among an out-of-order core and an in-order core to achieve maximum performance and power savings is depicted. In flow 505, in response to identifying a region of program code, which includes a first code type optimized for a first processor core, as hot code, associating the region of program code with a translated hot region, which includes the region of program code translated from the first code type to a second type that is to be optimized for a second processor core.

In one embodiment, the first processor core includes an out-of-order processor core, the first code type includes an out-of-order code type optimized for the out-of-order processor core, the second processor core includes an in-order processor core, and the second code type includes an in-order code type optimized for the in-order processor core. As one example, the out-of-order processor core is associated with decode logic that recognizes a first Instruction Set Architecture (ISA) and the in-order processor core is associated with decode logic that recognizes a second ISA. Here, the second code type is further optimized for the second ISA.

In one embodiment, decode logic associated with the first processor core is to decode at least one instruction from the program code indicating the region of program code is hot code. Here, a user may include the instruction in the program code to identify the hot region. Or, a compiler, when compiling the program code, may insert the instruction in response to analysis of the program code. In another embodiment, hardware monitors execution of the region of the program code on the first core and identifies the region of program code as hot code based on the hardware monitoring.

In addition, the region of program code may be associated with a translated hot region through updating an entry in a data structure with a reference to the region of the program code associated with a reference to the translated hot region. For example, the references to the translated hot region may include: an address, an instruction address, a location within a cache memory, a program counter value, and an instruction opcode.

In flow 510, the translated hot region on the second processor core is executed in response to encountering the region of program code during execution of the program code with the first processor core. As an example, when the first processor core's instruction pointer references the hot region of code, the translated region is executed on the second processor. However, any time for encountering an instruction may trigger execution on the second core. For example, fetching of a specific address or decoding of a specific instruction may instead trigger the execution.

In one embodiment, power considerations are also taken into account when identifying and distributing code among cores. As an illustrative example, when t the second processor core executes the translated hot region, the first processor core is transitioned into a low power state to save power. Moreover, specific power considerations may limit both cores from operating at maximum power at the same time in one embodiment.

As a result of coupling a native core with a different co-designed core the best of power and execution benefits are potentially obtained even within a single application. For example, with an out-of-order core and a software managed, in-order core, code that is not efficient on the software-managed core is migrated to the out-of-order core. And inversely, the code that is not efficient on the out-of-order core is migrated to the software managed core. Through hardware, software, firmware, or a combination therefore parallel execution of native code, hot code detecting, and hot code optimization may be efficiently managed, while individual sections of multiple threads may be efficiently interleaved in a pipelined fashion between the out-of-order and in-order co-designed cores. As a result, maximum performance may be obtained, while achieving better power performance through different power efficiency techniques, such as placing the out-of-order core in a low power state during execution on the in-order core in some implemenations.

A module as used herein refers to any hardware, software, firmware, or a combination thereof. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices. However, in another embodiment, logic also includes software or code integrated with hardware, such as firmware or micro-code.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding propagated signals (e.g., carrier waves, infrared signals, digital signals); etc.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising: an integrated circuit including,
an out-of-order (OOO) processor core adapted to execute program code out of program order; and
an in-order processor core adapted to execute a hot portion of the program code in program order.

2. The apparatus of claim 1, wherein the integrated circuit further comprises monitor hardware adapted to identify the hot portion of the program code.

3. The apparatus of claim 2, wherein the monitor hardware adapted to identify the hot portion of program code comprises: the monitor hardware being adapted to:
monitor execution of the program code on the OOO processor core;
determine a recurrence pattern for the hot portion of the program code based on monitoring execution of the program code on the OOO processor core; and
identify the hot portion of the program code based on the recurrence pattern.

4. The apparatus of claim 3, wherein the monitor hardware adapted to determine a recurrence pattern for the hot portion of the program code based on monitoring execution of the program code on the OOO processor core comprises: the monitor hardware being adapted to determine a number of times the hot portion of the program code is executed over time; and wherein the monitor hardware adapted to identify the hot portion of the program code based on the recurrence pattern comprises: the monitor hardware being adapted to identify the hot portion of the program code in response to the number of times being greater than a hot code threshold.

5. The apparatus of claim 3, wherein the monitor hardware is included in a portion of the integrated circuit selected from the group consisting of the OOO processor core, the in-order processor core, and a non-associated portion of the integrated circuit that is not included within either the OOO processor core or the in-order processor core.

6. The apparatus of claim 2, wherein the monitor hardware adapted to identify the hot portion of program code comprises: the monitor hardware being adapted to measure a performance metric for the hot portion of the program code during execution on the OOO processor core and to identify the hot portion of program code in response to the performance metric on the OOO processor core being below a threshold.

7. The apparatus of claim 6, wherein the monitor hardware is also adapted measure a performance metric for the hot portion of the program code during execution on the in-order processor core and to indicate the hot portion of program code is no longer considered a hot portion of program code in response to the performance metric for the hot portion of the program code during execution on the in-order processor core being less than the performance metric for the hot portion of the program code during execution on the OOO processor core.

8. The apparatus of claim 1, wherein the integrated circuit further comprises:
collaboration hardware adapted to provide input values from the OOO processor core to the in-order processor core.

9. The apparatus of claim 8, wherein the collaboration hardware adapted to provide input values from the OOO processor core to the in-order processor core comprises: context switch logic adapted to perform at least a partial context switch from the OOO processor core to the in-order processor core, wherein the at least the partial context includes at least the input values.

10. The apparatus of claim 8, wherein the collaboration hardware adapted to provide input values from the OOO processor core to the in-order processor core comprises: direct access hardware adapted to read the input values from registers in the OOO processor core and write the input values to input registers in the in-order processor core.

11. The apparatus of claim 2, wherein the integrated circuit further includes code storage logic to hold optimization code, when executed, to optimize the hot portion of the program code for execution on the in-order processor core, and wherein the optimization code is to be executed to optimize the hot portion of the program code in response to the monitor hardware identifying the hot portion of the program code.

12. The apparatus of claim 11, wherein the optimization code includes optimization microcode, and wherein the optimization microcode, when executed, to optimize the hot portion of the program code for execution on the in-order processor core comprises: the optimization microcode, when executed, to translate the hot portion of the program code from a first Instruction Set Architecture (ISA) recognized by decoders of the OOO processor core to a second ISA recognized by decoders of the in-order processor core.

13. The apparatus of claim 12, wherein the in-order processor core is to be associated with a code cache, the code cache being adapted to hold an optimized version of the second portion of the program code after translation of the hot portion of the program code from the first ISA to the second ISA.

14. The apparatus of claim 2, wherein the integrated circuit further includes trigger hardware adapted to:
indicate the hot portion of the program code is hot code in response to the monitor hardware identifying the hot portion of the program code, and
trigger execution of the hot portion of program code on the in-order processor core in response to the OOO processor core encountering the hot portion of the program code and the trigger hardware indicating the hot portion of the program code is hot code.

15. The apparatus of claim 14, wherein the trigger hardware adapted to indicate the hot portion of the program code is hot code comprises the trigger hardware adapted to hold a reference to the hot portion of the program code associated with a reference to an optimized version of the hot portion of the program code, which is optimized to be executed on the in-order processor core.

16. An apparatus comprising: a processor including,
an out-of-order core adapted to execute program code;
a co-designed core; and
a code distribution module adapted to identify a hot portion of the program code and to optimize the hot portion of the program code for the co-designed core to obtain optimized hot code,
wherein the co-designed core is to execute the optimized hot code in response to the code distribution module identifying the hot portion of the program code and the out-of-order core encountering the hot portion of the program code for execution.

17. The apparatus of claim 16, wherein the code distribution module adapted to identify the hot portion of the program code comprises: decode logic adapted to decode a hot code identifier instruction from the program code, which is to identify the hot portion of the program code.

18. The apparatus of claim 16, wherein the code distribution module adapted to identify the hot portion of the program code comprises a monitor module adapted to monitor execution of the program code on the out-of-order core and identify the hot portion of the program code from the monitoring of execution of the program code on the out-of-order core.

19. The apparatus of claim 18, wherein the monitor module comprises execution logic in the co-designed core adapted to execute monitoring code, wherein the monitoring code, when executed by the execution logic in the co-designed core, is to monitor execution of the program code on the out-of-order core and identify the hot portion of the program code.

20. The apparatus of claim 16, wherein the code distribution module adapted to optimize the hot portion of the program code for the co-designed core to obtain optimized hot code comprises execution logic to execute translation code, wherein the translation code, when executed, is to translate the hot portion of the program code to obtain the optimized hot code, and wherein the hot portion of the program code includes instructions that are part of a first Instruction Set Architecture (ISA) recognizable by decoders of the out-of-order core and the optimized hot code includes instructions that are part of a second ISA recognizable by decoders of the co-designed core.

21. The apparatus of claim 16, wherein the co-designed core is to execute the optimized hot code in response to the code distribution module identifying the hot portion of the program code and the out-of-order core encountering the hot portion of the program code for execution comprises: in response to a program counter associated with the out-of-order core referencing an instruction address associated with the hot portion of the program code and a mapping table associating the hot portion of the program code with the optimized hot code to indicate the hot portion of the program code is hot code, the co-designed core is to execute the optimized hot code.

22. The apparatus of claim 21, further comprising a code cache to be associated with the co-designed core, wherein a mapping table associating the hot portion of the program code with the optimized hot code to indicate the hot portion of the program code is hot code comprises: an entry of the mapping table holding a reference to the hot portion of the program and a reference to the optimized hot code, wherein the reference to the optimized hot code includes a reference to a location of the optimized hot code in the code cache.

23. The apparatus of claim 16, wherein the processor is coupled to a system memory, which is selected from a group consisting of a Random Access Memory (RAM), double-data-rate (DDR) RAM, and a buffered RAM, wherein the system memory is to hold the program code.

24. A processor comprising:
a first core associated with decode logic adapted to recognize a first Instruction Set Architecture (ISA) type;
a second core associated with decode logic adapted to recognize a second Instruction Set Architecture (ISA) type;
a monitor module to monitor execution of program code, which is of the first ISA type, on the first core and to identify a hot region of the program code; and
a translation module to translate the hot region of the program code from the first ISA type to the second ISA type to obtain a translated hot region of the program code;
wherein the second processor core is to execute the translated hot region of the program code in response to the first processor core subsequently encountering the hot region of the program code and the monitor hardware identifying the hot region of the program code.

25. The apparatus of claim 24, wherein the monitor module includes monitor code, when executed, to monitor execution of program code on the first core and to identify a hot region of the program code; and wherein the translation module includes translation code, when executed, to translate the hot region of the program code to obtain the translated hot region of the program code in at least partially in parallel with execution of the program code on the first core.

26. The apparatus of claim 24, wherein the monitor module includes monitor hardware to monitor execution of program code on the first core and to identify a hot region of the program code.

27. The apparatus of claim 24, wherein the second core is adapted to reside in a low power state while the monitor module is monitoring execution of the program code on the first core and identifying the hot region of the program code, and wherein the first core is adapted to reside in a low power state while the second core is executing the translated hot region of the program code.

28. The apparatus of claim 24, wherein the first core is adapted to execute a cold region of the program code in parallel to the second core executing the translated hot region of the program code.

29. The apparatus of claim 24, wherein the first core and the second core are adapted not to operate in a maximum power state at the same time.

30. A machine readable medium including code, which when executed by the machine, causes the machine to perform the operations of:
monitoring execution of program code on an out-of-order processor core in a processor within the machine;
identifying hot sections of the program code;
optimizing the hot sections of the program code for execution on a co-designed processor core within the machine to obtain optimized hot sections of the program code;
distributing the optimized hot sections of the program code to the co-designed processor core; and
executing the optimized hot sections of the program code with the co-designed processor core.

31. The machine readable medium of claim 35, wherein monitoring execution of program code on an out-of-order processor comprises: determining a performance metric associated with sections of the program code.

32. The machine readable medium of claim 31, wherein identifying hot sections of the program code comprises: determining the sections of the program code are hot sections of the program code based on the performance metric in comparison to a performance threshold.

33. The machine readable medium of claim 35, wherein optimizing the hot sections of the program code for execution on a co-designed processor core comprises:
translating the hot sections of the program code from native instructions, which are recognizable by decode logic associated with the out-of-order processor core, to co-designed instructions, which are recognizable by decode logic associated with the co-designed core.

34. The machine readable medium of claim 35, wherein distributing the optimized hot sections of the program code to the co-designed processor core comprises: writing the optimized hot sections of the program code to a code cache associated with the co-designed core.

35. A machine readable medium including code, which when executed by the machine, causes the machine to perform the operations of:
in response to identifying a region of program code, which includes a first code type optimized for a first processor core in the machine, as hot code, associating the region of program code with a translated hot region, which includes the region of program code translated from the first code type to a second type that is to be optimized for a second processor core in the machine; and
in response to encountering the region of program code during execution of the program code with the first processor core, executing the translated hot region on the second processor core responsive to the region of program code being associated with the translated hot region.

36. The machine readable medium of claim 35, wherein the first processor core includes an out-of-order processor core, the first code type includes an out-of-order code type optimized for the out-of-order processor core, the second processor core includes an in-order processor core, and the second code type includes an in-order code type optimized for the in-order processor core.

37. The machine readable medium of claim 36, wherein the out-of-order processor core is associated with decode logic that recognizes a first Instruction Set Architecture (ISA), the first code type is further optimized for the first ISA, the in-order processor core is associated with decode logic that recognizes a second ISA, and the second code type is further optimized for the second ISA.

38. The machine readable medium of claim 35, wherein identifying the region of program code as hot code comprises decode logic associated with the first processor core decoding at least one instruction from the program code indicating the region of program code is hot code.

39. The machine readable medium of claim 35, wherein identifying the region of program code as hot code comprises hardware in the machine to monitor execution of the region of the program code on the first core and identify the region of program code as hot code based on the hardware monitoring execution of the region of the program code on the first core.

40. The machine readable medium of claim 35, wherein associating the region of program code with a translated hot region comprises updating an entry in a data structure with a reference to the region of the program code associated with a reference to the translated hot region, and wherein the reference to the region of the program code and the reference to the translated hot region are each individually selected from a group consisting of: an address, an instruction address, a location within a cache memory, a program counter value, and an instruction opcode.

41. The machine readable medium of claim 35, wherein in response to encountering the region of program code during execution of the program code with the first processor core and the region of program code being associated with the translated hot region, transitioning the first processor core into a low power state during the second processor core executing the translated hot region.

42. A method comprising:
identifying a hot section of program code;
optimizing the hot section of the program code for execution with an in-order processor core to obtain an optimized hot section of the program code;
executing the program code with an out-of-order core of a processor; and
executing the optimized hot section of the program code with the in-order processor core, instead of executing the hot section of the program code with the out-of order processor core, in response to the out-of-order core encountering the hot section of the program code during executing the program code with the out-of-order processor and identifying the hot section of program code.

43. The method of claim 42, further comprising associating the hot section of the program code with the optimized hot section of the program code.

44. The method of claim 43, wherein associating the hot section of the program code with the optimized hot section of the program code comprises storing a reference to the hot section of the program code and a reference to the optimized hot section in an entry of a code mapping table.

45. The method of claim 42, wherein identifying a hot section of program code comprises: monitoring a performance metric during execution of a section of the program code with the out-of-order processor core, and identifying the section of the program code as the hot section of program code based on the performance metric in comparison with a performance threshold.

46. The method of claim 45, further comprising monitoring the performance metric during execution of the optimized hot section of the program code with the in-order processor core, and indicating the hot section of program code is to be executed with the out-of-order core, instead of the optimized hot section of the program code to be executed with the in-order core, in response to the performance metric during execution of the optimized hot section of the program code with the in-order processor core indicating less performance than the performance metric during execution of a section of the program code with the out-of-order processor core.

47. The method of claim 42, wherein optimizing the hot section of the program code for execution with an in-order processor core to obtain an optimized hot section of the program code comprises executing binary translation code to translate the program code to the optimized hot section of the program code.

48. A machine readable medium including code, which when executed by the machine, causes the machine to perform the operations of claim 42.
